(19) United States
(12) Patent Application Publication
(10) Pub. No.: US 2026/0360640 A1
(43) Pub. Date: Nov. 12, 2026

(54) HIGH-VOLTAGE INTERRUPTER CHAMBER

(71) Applicant: SAFRAN ELECTRICAL & POWER, BLAGNAC (FR)

(72) Inventors: Kévin ENOUF, MOISSY-CRAMAYEL (FR); Guillaume PRIEUR, MOISSY-CRAMAYEL (FR); Cecil BELTAN, MOISSY-CRAMAYEL (FR); Arnaud BADAULT, MOISSY-CRAMAYEL (FR)

(21) Appl. No.: 19/134,824

(22) PCT Filed: Dec. 20, 2023
(86) PCT No.: PCT/FR2023/052074

§ 371 Date: Jun. 2, 2025

(30) Foreign Application Priority Data
Dec. 22, 2022 (FR) FR2214292

(51) Int. Cl. H01H 33/18; H01H 1/20; H01H 33/06

(52) U.S. Cl. CPC H01H 33/182; H01H 1/20; H01H 33/06

(57) ABSTRACT

A high-voltage interrupter chamber having a vertical main axis A and comprising two fixed contacts offset with respect to each other in a transverse direction perpendicular to the main axis A and a movable contact, wherein the movable contact is mounted so as to be translatably movable with respect to the fixed contacts between a closed position and an open position, the interrupter chamber further comprising permanent magnets that are distributed on either side of the fixed contacts and the movable contact, wherein it comprises a screen made of an electrically insulating material, which is disposed between the fixed contacts.

### TECHNICAL FIELD

The invention relates to a movable contact interrupter chamber that is designed to improve the quality of the interruption of an electric arc.

### PRIOR ART

A double-cutout interrupter chamber comprises two fixed contacts that are each connected to a terminal of the interrupter chamber and a movable contact.

The movable contact is movable in the interrupter chamber between a position for connecting the fixed contacts, wherein it is simultaneously in contact with the two fixed contacts, and an isolation position wherein the movable contact is located at a distance from the two fixed contacts.

When the interrupter chamber is opened, the breakage of the electrical contact between the movable contact and each fixed contact produces electric arcs.

In order to limit the formation of these electric arcs, the interrupter chamber comprises permanent magnets distributed around the fixed contacts. The magnetic field generated by these magnets interacts with the electric arc to move it under the action of the Laplace force.

There are two types of interrupter chambers, depending on whether the movable contact moves rotationally or moves translatably.

In the second type of interrupter chamber, for which the movable contact translatably moves, the fixed contacts are carried by the same support plate and are therefore disposed on the same side of the movable contact.

According to this embodiment, the magnets are disposed longitudinally and transversely on either side of the contacts, with respect to the main axis of translation of the movable contact.

The magnets are thus located far apart from one another, which results in a weak magnetic field in the centre of the interrupter chamber.

In this case, if an electric arc forms at the centre of the interrupter chamber, the effectiveness of the interruption is limited to this level, there is also a risk that the electric arc will catch on the translational axis and then short-circuit the two fixed contacts.

The aim of the invention is to propose an improved interrupter chamber making it possible to improve the interruption of electric arcs forming near the central axis.

### DISCLOSURE OF THE INVENTION

The invention proposes a high-voltage interrupter chamber having a vertical main axis A and comprising two fixed contacts offset with respect to each other in a transverse direction perpendicular to the main axis A and a movable contact,
wherein the movable contact is mounted so as to be translatably movable with respect to the fixed contacts in the direction of the main axis A between a closed position wherein the movable contact is simultaneously in electrical contact with the two fixed contacts and an open position wherein the movable contact is located axially at a distance from the two fixed contacts,
the interrupter chamber further comprising first permanent magnets and second permanent magnets that are distributed longitudinally or transversely on either side of the fixed contacts and of the movable contact,
characterised in that it comprises a screen made of an electrically insulating material, which is disposed between the fixed contacts.

Preferably, the screen is integral with the contact translatably movable with respect to the fixed contacts.

Preferably, the longitudinal dimension of the screen is greater than the longitudinal dimension of the fixed contacts and the screen protrudes longitudinally at the two longitudinal ends thereof relative to the fixed contacts.

Preferably, the vertical dimension of the screen is greater than a vertical clearance between the movable contact and each fixed contact when the movable contact is in the open position and the screen protrudes vertically downwards and upwards with respect to this vertical clearance.

Preferably, the screen carries two third permanent magnets that are arranged transversely between the fixed contacts.

Preferably, the interrupter chamber comprises a guide rod performing a translational guidance of the movable contact and the screen is translatably guided by the guide rod.

Preferably, each third permanent magnet is arranged transversely between the guide rod and a fixed contact.

Preferably, the first permanent magnets are arranged longitudinally on either side of the fixed contacts.

Preferably, the second permanent magnets are arranged transversely on either side of the fixed contacts.

### BRIEF DESCRIPTION OF THE DRAWINGS

FIG. 1 is a schematic top view representation of an interrupter chamber according to the invention.

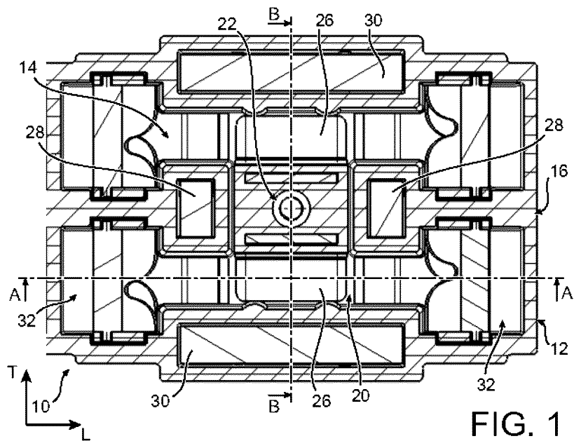

FIG. 2 is a sectional view along the plane A-A of the interrupter chamber shown in FIG. 1.

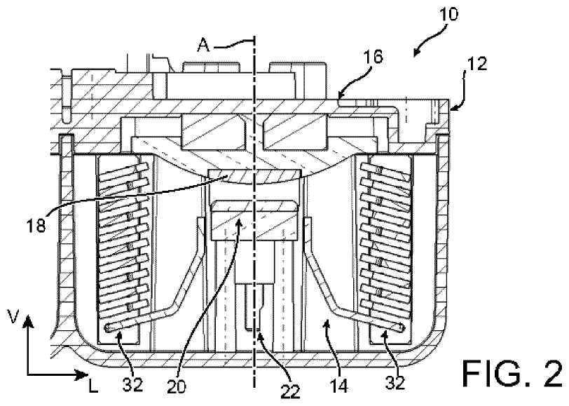

FIG. 3 is a sectional view along the plane B-B of the interrupter chamber shown in FIG. 1.

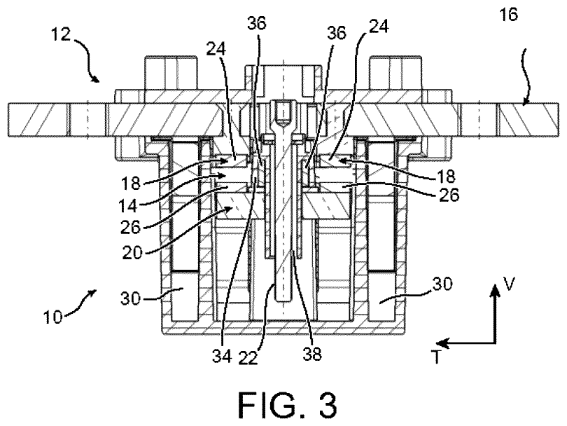

### DETAILED DISCLOSURE OF PARTICULAR EMBODIMENTS

For the description of the invention, the vertical, longitudinal and transverse orientations according to the mark V, L, T indicated in the figures will be adopted without limitation.

The figures show an interrupter chamber 10 for a high-voltage circuit, which makes it possible to break the flow of electrical current within a circuit.

Preferably, an installation comprises a plurality of similar interrupter chambers 10 arranged in parallel, each of which is associated with an electrical conductor.

In the following description, reference will be made to a single interrupter chamber. It will be understood that this description will apply in the same way to any other interrupter chamber 10.

The interrupter chamber 10 comprises a body 12 made of an electrically insulating material. It delimits a volume 14 filled with a dielectric gas promoting arc extinguishing. Preferably, the dielectric gas is air but it will be understood that it may be any other dielectric gas capable of performing the arc extinguishing function.

The interrupter chamber 10 has a symmetry along a vertical main axis A, which is central thereto.

The body 12 comprises a horizontal support plate 16 that carries two fixed contacts 18 each of which is connected to a terminal of the interrupter chamber 10. The two terminals of the interrupter chamber 10 (not shown) are in turn connected to two electrical conductors to which the interrupter chamber 10 is intended to connect.

Here, the two fixed contacts 18 are offset from one another according to the transverse direction and they are located at a distance from one another making it possible to electrically isolate them.

The interrupter chamber 10 also comprises a movable contact 20 made of an electrically conductive material. The movable contact 20 is intended to electrically connect, or not, the two fixed contacts 18 to electrically connect the two electrical conductors associated with the interrupter chamber 10.

The movable contact 20 is mounted so as to be translatably movable in the body 12 in the vertical direction between an open position shown in the figures wherein the movable contact 20 is located vertically at a distance from the two fixed contacts 18 and a closed position not shown wherein the movable contact 20 is simultaneously in contact with the two fixed contacts 18.

Here, the movable contact 20 is located vertically below the fixed contacts 18, the movement of the movable contact 20 from the open position to the closed position consists in an upward translation of the movable contact 20. It will be understood that the invention is not limited to this embodiment and that according to alternative embodiments, the movable contact can be offset longitudinally and/or transversely or be located vertically over the fixed contacts 18 without departing from the invention.

The interrupter chamber 10 also comprises means (not shown) for driving the movable contact moving towards the open position or towards the closed position, depending on whether the movable contact is in one or the other of these two positions.

The body 12 also carries a guide rod 22 of the movable contact 20 in vertical translation. According to a preferred but non-limiting embodiment, the guide rod 22 is coaxial to the main axis A.

The guide rod 22 here extends vertically downwards from the support plate 16. The guide rod 22 is further made of an electrically conductive metal material.

The movable contact 20 comprises a central orifice coaxial to the main axis A, wherein the guide rod 22 is received.

During an opening phase of the interrupter chamber 10, to interrupt the flow of electrical current in the electrical conductor, the movable contact 20 is moved in vertical downward translation. Following this translation, the electrical contact between each fixed contact 18 and the movable contact 20 is broken.

An electric arc then forms between the movable contact 20 and a fixed contact 18 or the two fixed contacts 18.

Each fixed contact 18 comprises a contact pad 24 intended to come into electrical contact with the movable contact 20 and the movable contact 20 also comprises two contact pads 26 each of which is intended to come into contact with a contact pad 24 of a fixed contact 18 when the movable contact 20 is in the closed position.

It is between the contact pads 24, 26 of each of the movable contact 20 and of a fixed contact 18 that the electric arc is intended to be formed.

The contact pads 24, 26 are made of an electrically conductive material that is inclined to deteriorate less under the action of the electric arc.

The material constituting the contact pads 24, 26 is further selected to promote the mobility of the arc roots, that is to say it promotes the movement of the transition area between the pad and the rest of the arc. The mobility of the arc root has an impact on how quickly the arc moves to an area designed to help extinguish the arc.

The interrupter chamber 10 also comprises means for extinguishing the electric arcs that form when the movable contact 20 is separated from the fixed contacts 18.

These extinguishing means comprise the dielectric gas, that is to say here air, which fills the volume 14 of the body 12 and the permanent magnets 28, 30 that are distributed longitudinally and transversely around the fixed contacts 18 and the movable contact 20. Two first permanent magnets 28 are arranged longitudinally on either side and at a distance from the contacts 18, 20. Two second permanent magnets 30 are arranged transversely on either side and at a distance from the contacts 18, 20.

The first permanent magnets 28 and the second permanent magnets 30 are attached to the body 12. The vertical dimension thereof and the vertical position thereof are defined so that an upper end of each permanent magnet is located vertically above the fixed contacts 18 and a lower end of each permanent magnet 28, 30 is located vertically below the movable contact 20 when the movable contact 20 is in the open position thereof, that is to say the vertically lower position thereof.

These first permanent magnets 28 and second permanent magnets 30 are disposed in the interrupter chamber 10 to generate magnetic fields that are oriented vertically in the areas where the electric arcs occur. These resulting magnetic fields then exert on the electric arcs an electromagnetic force, called Laplace force, which drives each electric arc in the direction of an interruption area 32.

Since the permanent magnets 28, 30 are arranged longitudinally and transversely at a distance from the main axis A, the intensity of the Laplace force that they make it possible to generate is low at this level. Indeed, the amplitude of the magnetic field that a permanent magnet 28, 30 produces decreases when moving away from the magnet, that is to say here when moving closer to the main axis A.

In particular, the second permanent magnets 30 are disposed at a significant transverse distance with respect to the main axis A. Thus, the amplitude of the magnetic field that they produce at the contact pads 24, 26 is relatively low.

Between the first permanent magnets 28 and the second permanent magnets 30, and outside the area of the movable contact 20, together produce a greater magnetic field since they interact with each other.

To improve the magnetic field near the main axis A and also to prevent an electric arc from catching on the guide rod 22, the interrupter chamber 10 further comprises a screen 34 made of an electrically insulating material, which is disposed between the fixed contacts 18.

The screen 34 consists of a globally parallelepiped element that further surrounds the guide rod 22. For this purpose, the screen 34 comprises a housing 38 coaxial to the main axis A, wherein the guide rod 22 is received.

The longitudinal dimension of the screen 34 is preferably greater than the longitudinal dimension of the fixed contacts 18 and the screen 34 protrudes longitudinally at the two longitudinal ends thereof with respect to the fixed contacts 18.

In addition, according to a preferred embodiment, the vertical dimension of the screen 34 is greater than a vertical clearance between the movable contact 20 and each fixed contact 18, when the movable contact 20 is in the open position. In addition, the vertical dimension of the screen 34 is defined so that the screen 34 protrudes vertically both downwards and upwards with respect to this vertical clearance.

Thus, the screen 34 prevents any electric arc from forming between a fixed contact 18 and the movable contact 20 from moving towards the guide rod 22 and even less towards the other fixed contact 18.

The screen further carries two third permanent magnets 36 that are arranged transversely on either side of the guide rod 22. These third permanent magnets 36, which are therefore integral with the screen, are also located transversely between the two fixed contacts 18. That is to say, each third permanent magnet 36 is located transversely between the guide rod 22 and a fixed contact 18.

The third permanent magnets 36 generate additional magnetic fields the intensity of which near the main axis A is sufficiently high so that the produced Laplace force can drive an electric arc in the direction of the interruption area 32.

According to a first embodiment, the screen 34 is attached in the body 12.

According to a second embodiment, the screen 34 is mounted so as to be translatably movable in the body 12. Preferably, according to this second embodiment, the screen 34 is integral with the movable contact 20 in vertical translation with respect to the fixed contacts 18.

### NOMENCLATURE

10: interrupter chamber
12: body
14: volume
16: support plate
18: fixed contacts
20: movable contact
22: guide rod
24: contact pads of the fixed contacts
26: contact pads of the movable contact
28: first permanent magnets
30: second permanent magnets
32: interruption area
34: screen
36: third permanent magnets
38: housing

What is claimed is:

1. A high-voltage interrupter chamber having a vertical main axis A and comprising two fixed contacts offset with respect to each other in a transverse direction perpendicular to the main axis A and a movable contact,
wherein the movable contact is mounted so as to be translatably movable with respect to the fixed contacts in the direction of the main axis A between a closed position wherein the movable contact is simultaneously in electrical contact with the two fixed contacts and an open position wherein the movable contact is located axially at a distance from the two fixed contacts,
the interrupter chamber further comprising first permanent magnets and second permanent magnets that are distributed longitudinally or transversely on either side of the fixed contacts and of the movable contact,
the interrupter chamber further comprising a screen made of an electrically insulating material, which is disposed between the fixed contacts,
wherein the screen is integral with the translatably movable contact with respect to the fixed contacts.

2. The interrupter chamber according to claim 1, wherein the longitudinal dimension of the screen is greater than the longitudinal dimension of the fixed contacts and the screen protrudes longitudinally at the two longitudinal ends thereof with respect to the fixed contacts.

3. The interrupter chamber according to claim 1, wherein the vertical dimension of the screen is greater than a vertical clearance between the movable contact and each fixed contact when the movable contact is in the open position and the screen protrudes vertically downwards and upwards with respect to this vertical clearance.

4. The interrupter chamber according to claim 1, wherein the screen carries two third permanent magnets that are arranged transversely between the fixed contacts.

5. The interrupter chamber according to claim 1, which comprises a guide rod performing a translational guidance of the movable contact, wherein the screen is translatably guided by the guide rod.

6. The interrupter chamber according to claim 5, claim 5, wherein each third permanent magnet is arranged transversely between the guide rod and a fixed contact.

7. The interrupter chamber according to claim 1, wherein the first permanent magnets are arranged longitudinally on either side of the fixed contacts.

8. The interrupter chamber according to claim 1, wherein the second permanent magnets are arranged transversely on either side of the fixed contacts.

9. An electrical installation comprising one or more interrupter chambers according to claim 1.
